(19) United States
(12) Patent Application Publication
(10) Pub. No.: US 2009/0144476 A1
(43) Pub. Date: Jun. 4, 2009

(54) HOT PLUG IN A LINK BASED SYSTEM

(76) Inventors: Xiaohua Cai, Shanghai (CN); Yufu Li, Shanghai (CN); Murugasamy Nachimuthu, Hillsboro, OR (US)

Correspondence Address: Barnes & Thornburg, LLP, c/o CPA Global, P.O. Box 52050, Minneapolis, MN, 55402, US

(21) Appl. No.: 11/949,970

(22) Filed: Dec. 4, 2007

(51) Int. Cl. G06F 13/00

(52) U.S. Cl. 710/302

(57) ABSTRACT

Machine-readable medium, processes and systems for adding and/or removing components from a running computing device based upon a static topology table and a dynamic topology table are disclosed.

### BACKGROUND

In order to improve the reliability, availability and serviceability, computing devices such as servers and work stations may support hot-pluggable components. In particular, such computing devices may enable a technician to add components to and/or remove components from a computing device while the computing device is running. In response to components being added to or removed from the computing device, the computing device determines which components have been added and/or removed and takes actions to utilize the newly added component(s) and/or cease use of the removed component(s).

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows an embodiment of a computing device to which a components is being added.

FIG. 2 shows an embodiment of a process of updating the computing device in order to use the newly added component.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present disclosure. It will be appreciated, however, by one skilled in the art that embodiments of the disclosure may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

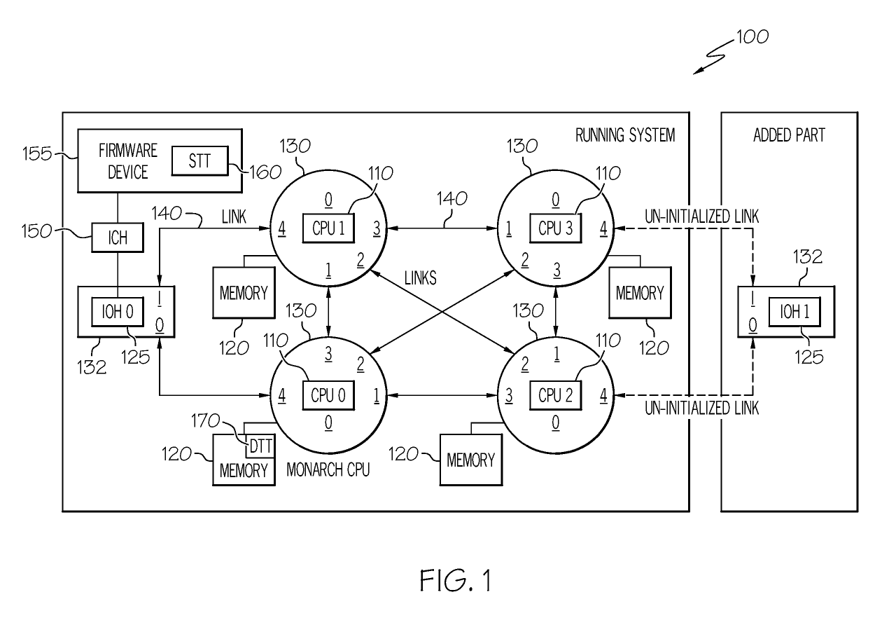

Referring now to FIG. 1, an embodiment of a computing device 100 is shown having processors 110, memory 120 and I/O hubs 125. It should be noted that, while the computing device 100 is shown in FIG. 1 with four processors, other embodiments may include a single processor 110 or another number of processors 110. Each processor 110 may be seated or plugged into a socket 130 and each I/O hub 125 may be seated or plugged into a socket 132. Each socket 130, 132 may provide a high speed serial interconnect that has one or more ports 0-4. As shown, the sockets 130 associated with processors 110 have a local port 0 and four external ports 1, 2, 3, 4; however sockets 130 having different numbers of local ports and external ports are also contemplated. The local port 0 of each socket 130 may be used by the high speed interconnect to communicate with processing cores of the respective processor 110 and the external ports 1-4 may be used to communicate with other sockets 130, 132 and their respective components. Similarly, the sockets 132 are shown with two external ports 0, 1; however sockets 132 having different numbers of local ports and external ports are also contemplated. The ports of sockets 132 may be used to communicate with other sockets 130, 132 and their respective components. To this end, high speed serial point-to-point links 140 may connect external ports of a sockets 130, 132 to external ports of other sockets 130, 132 of the computing device 100.

Communication between processors 110 and between processors 110 and the I/O hubs 125 are performed using packets over the links 140. Each component added to hot-plug sockets 130, 132 comprises a routing table array (RTA). The RTA may provide information to route packets to other sockets 130, 132. The components may further support mapping of their respective memory address spaces into a globally shared memory space of the computing device 110 via a system address decoder (SAD). In particular, the system address decoder may map the local memory 120 associated with a processor 110 to the global address space of the computing device 100. Similarly, the system address decoder may map addressable registers of added components to the global address space of the computing device 100. For each link 140, the sockets 130, 132 may exchange socket identifiers, socket types, and other information between both ends of the link 140. Registers associated with the ports of each socket 130 may store the exchanged information. After the initialization of a link 140, each port may discover the socket 130, 142 and port on the remote side by accessing its local port registers.

Components such as processors 110 and I/O hubs 125 that are to be attached to sockets 130, 132 may support a quiesce mode in which the components cease normal traffic on the links 140. Quiescing the traffic permits the computing device 100 to initialize links 140 associated with newly added components and to update routing table arrays and system address decoders to reflect the added components. Similarly, quiescing the traffic permits the computing device 100 to disable links 140 associated with removed components and to update routing table arrays and system address decoders to reflect the removed components.

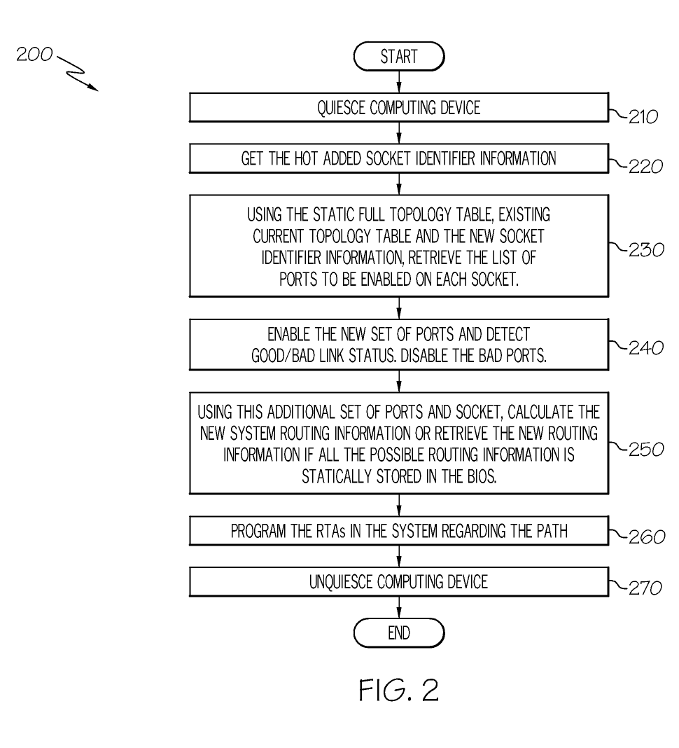

The IOH 125 may interface I/O devices of the system to the high speed links 140. As shown, the IOH 125 may operably connect an I/O controller hub (ICH) 150 to the links 140. The ICH 150 may include controllers for various I/O devices. For example, the ICH 150 may include hard disk controllers, PCI Express controllers, USB controllers, video display controllers, audio controllers, and network controllers to name a few. The ICH 150 may further provide an interface to a firmware device 155 which stores Basic Input/Output System (BIOS) routines which the processors 110 may execute in order to initialize the computing device 100. In particular, the firmware device 155 may store one or more system management interrupt handlers that the processors 110 may execute in order to add a component to or remove a component from the running computing device 100. The firmware device 155 may also store a static topology table 160 used by the processors 130 in processing hot plug additions of components to sockets 130, 132 and hot plug removal of components to sockets 130, 132. Details of a system management interrupt handler that uses the static topology stable 160 in discussed in more detail below in regard to FIG. 2.

The location of the sockets 130, 132 are fixed in the computing device 100, hence the links 140 between the sockets 130, 132 are also fixed. Accordingly, the static topology table 160 may store data representative of the static link connections between sockets 130, 132 so that processors 110 may identify the link connection between sockets 130, 132 from the data of the static topology table 160. In particular, the processors 110 may use the information of the static topology table to identify ports to enable when components are added to sockets 130, 132 and to identify ports to disable when components are removed from sockets 130, 132. The static topology table permits the processors 110 to quickly discover the hot plugged socket when a component is added or removed without requiring a depth-first or breadth-first search of the registers associated with each port of the computing device.

In FIG. 1 and the Tables that follow, labels CPU0, CPU1, CPU2, CPU3, IOH0, and IOH1 are used to indicate identifiers for sockets 130, 132 and components of the sockets 130, 132. It should be appreciated that the human readable labels are for the convenience of the reader. The socket identifiers may in fact comprise numerical values that may have no particular human readable significance.

Contents of an illustrative static topology table 160 are shown in Table 1. In particular, the contents of the static topology table 160 of Table 1 reflect the static topology of the computing device 100 shown in FIG. 1. Each row of the static topology table 160 corresponds to a particular socket 130, 132 of the computing device 100. For example, the first row of the static topology table 160 shown in Table 1 identifies the ports of the CPU0 socket 130 and the ports to which the ports of the CPU0 socket 130 are connected. In particular, the first row indicates that a link 140 connects Port 1 of CPU0 socket 130 to Port 3 of CPU2 socket 130, a link 140 connects Port 1 of CPU0 socket 130 to Port 2 of CPU3 socket 130, a link 140 connects Port 3 of CPU0 socket 130 to Port 1 of CPU1 socket 130, and yet another link 140 connects Port 4 of CPU0 socket 130 to Port 0 of IOH0 socket 132. Similarly, the last row of the static topology shown in Table 1 identifies the ports of the IOH1 socket 132 and the ports to which the ports of the IOH1 socket 132 are connected. As such, the CPU0 processor 110 using the IOH1 socket identifier may determine from the static topology table 160 that a link 140 connects Port 0 of IOH1 socket 132 to Port 4 of CPU2 socket 130 and that another link 140 connects Port 1 of IOH1 socket 132 to Port 4 of CPU3 socket 130.

TABLE 1
Static Topology Table

| | Port on | Remote Socket | Port on |
|---|---|---|---|
| Socket Identifier | Local Socket | Identifier | Remote Socket |
| CPU0 | 1 | CPU2 | 3 |
| | 2 | CPU3 | 2 |
| | 3 | CPU1 | 1 |
| | 4 | IOH0 | 0 |
| CPU1 | 1 | CPU0 | 3 |
| | 2 | CPU2 | 2 |
| | 3 | CPU3 | 1 |
| | 4 | IOH0 | 1 |
| CPU2 | 1 | CPU3 | 3 |
| | 2 | CPU1 | 2 |
| | 3 | CPU0 | 1 |
| | 4 | IOH1 | 0 |
| CPU3 | 1 | CPU1 | 3 |
| | 2 | CPU0 | 2 |
| | 3 | CPU2 | 1 |
| | 4 | IOH1 | 1 |
| IOH0 | 0 | CPU0 | 4 |
| | 1 | CPU1 | 4 |
| IOH1 | 0 | CPU2 | 4 |
| | 1 | CPU3 | 4 |

As shown, the processors 110 may also maintain a dynamic topology table 170 in memory 120. The dynamic topology table 170 may include connection information that indicates to which socket 130, 132 a port has an established link 140. It should be noted that a port may be physically connected to another port via a link 140, but despite the physical connection an established link 140 may not be present. For example, the port on either end of the physical link 140 may be disabled thus preventing a communications link being established between the two ports. Accordingly, while the physical link connections between the sockets 130, 132 may be static as reflected in the static topology table 160, established links between the sockets 130, 132 is dynamic due to components being added to or removed from sockets 130, 132 and/or the enabling or disabling of ports associated with a particular physical link 140.

Connection information of an illustrative dynamic topology table 170 is shown in TABLE 2. In particular, the connection information of the dynamic topology table 170 of TABLE 2 reflects the dynamic topology of the computing device 100 prior to the IOH1 I/O hub 125 being added to the IOH1 socket 132. Each row of the dynamic topology table 170 may correspond to a particular socket 130, 132 of the computing device 100. For example, the first row of the dynamic topology table 170 shown in TABLE 2 identifies the sockets 130, 132 to which the ports of the CPU0 socket 130 are connected via an established link 140. In particular, the first row indicates an established link 140 connects Port 1 of CPU0 socket 130 to CPU2 socket 130, an established link 140 connects Port 2 of CPU0 socket 130 to CPU3 socket 130, an established link 140 connects Port 3 of CPU0 socket 130 to CPU1 socket 130, and yet another established link 140 connects Port 4 of CPU0 socket 130 to IOH0 socket 132. Similarly, the last row of the dynamic topology shown in TABLE 2 indicates there are no established links to the ports of the IOH1 socket 132

TABLE 2
Dynamic Topology Table Connection Information

| | CPU0 | CPU2 | CPU3 | CPU1 | IOH0 | IOH1 |
|---|---|---|---|---|---|---|
| CPU0 | n/a | 1 | 2 | 3 | 4 | n/a |
| CPU2 | 3 | n/a | 1 | 2 | n/a | n/a |
| CPU3 | 2 | 3 | n/a | 1 | n/a | n/a |
| CPU1 | 1 | 2 | 3 | n/a | 4 | n/a |
| IOH0 | 0 | n/a | n/a | 1 | n/a | n/a |
| IOH1 | n/a | n/a | n/a | n/a | n/a | n/a |

The dynamic topology table 170 may further indicate the shortest distance between sockets 130, 132 of computing device 100. Processors 110 may use such information to configure routing table arrays of the components so that packets may travel between components via the shortest route. Shortest-Distance information of an illustrative dynamic topology table 170 is shown in TABLE 3. In particular, the shortest-distance information of the dynamic topology table 170 of TABLE 3 reflects the dynamic topology of the computing device 100 prior to the IOH1 I/O hub 125 being added to the IOH1 socket 132. Each row of the dynamic topology table 170 may correspond to a particular socket 130, 132 of the computing device 100. For example, the first row of the dynamic topology table 170 shown in TABLE 3 identifies shortest distance between ports of the CPU0 socket 130 and other sockets 130, 132 of the computing device 100. In particular, the first row indicates the distance between CPU0 socket 130 and CPU0 socket 130 is zero links 140, the distance between CPU0 socket 130 and CPU2 socket 130 is one (1) link 140, the distance between CPU0 socket 130 and CPU3 socket 130 is one (1) established link 140, the distance between CPU0 socket 130 and CPU1 socket 130 is one (1) established link 140, the distance between CPU0 socket 130 and IOH0 socket 132 is one (1) established link 140, CPU0 socket 130 has no established route to IOH1 socket 132.

TABLE 3
Dynamic Topology Table Shortest Route Information

| | CPU0 | CPU2 | CPU3 | CPU1 | IOH0 | IOH1 |
|---|---|---|---|---|---|---|
| CPU0 | 0 | 1 | 1 | 1 | 1 | n/a |
| CPU2 | 1 | 0 | 1 | 1 | 2 | n/a |
| CPU3 | 1 | 1 | 0 | 1 | 2 | n/a |
| CPU1 | 1 | 1 | 1 | 0 | 1 | n/a |
| IOH0 | 1 | 2 | 2 | 1 | 0 | n/a |
| IOH1 | n/a | n/a | n/a | n/a | n/a | n/a |

The sockets 130, 132 of the computing device 100 further have a socket identifier that unique identifies the respective socket 130, 132 in the computing device 100. Components may be added to the sockets 130, 132 and removed from the sockets 130, 132 while the computing device 100 is running. To this end, the sockets 130, 132 may generate a system management interrupt each time a component is added to a socket 130, 132 or removed from a socket 130, 132. As explained in more detail below, one or more processors 110 of the computing device 100 may receive the system management interrupt, may retrieve the socket identifier for the socket 130, 132 causing the system management interrupt, and may handle the addition and/or or removal of the component from the computing device 100 based upon the received socket identifier and the static topology table 150.

Referring now to FIGS. 1 and 2, an embodiment of a process 200 for handling the addition of a component to the running computing device 100 is shown. For the purpose of explanation, the process 200 is described from the context of adding the IOH1 I/O hub 125 to an IOH1 socket 132 of the running computing device 100. Further, the process 200 is also described from the context that the CPU0 processor 110 has been designated as a monarch processor that primarily handles processing of system management interrupts for the computing device 100.

As stated above, a system management interrupt is generated in response to a component being added to a socket 130, 132. Accordingly, one or more processors 110 of the computing device 100 may receive the system management interrupt in response to the IOH1 I/O hub 125 being added to the IOH1 socket 132. In response to the system management interrupt, the CPU0 monarch processor 110 at block 210 may quiesce the processors 110 and the I/O hubs 125 of computing device 100 to pause the traffic through the links 140. At block 220, the CPU0 processor 110 may retrieve the IOH1 socket identifier for the IOH1 socket 132 to which the IOH1 I/O hub 125 was added. In one embodiment, the IOH1 socket identifier is retained by system management interrupt hardware of the IOH0 I/O hub 125, thus permitting the CPU0 processor 110 to obtain the IOH1 socket identifier associated with the system management interrupt without querying each socket 130, 132 of the computing device 100.

At block 230, the CPU0 processor 110 may identify ports of the sockets 130, 132 that are to be enabled in order to establish one or more links 140 to the added component. In particular, the CPU0 processor 110 may identify the ports based upon the obtained IOH1 socket identifier, the static topology table 160 and the dynamic topology table 170. As mentioned above, TABLE 1 shows a static topology table 160 for the computing device 110 shown in FIG. 1. Based upon the last row of static topology table 160 which is associated with the IOH1 socket identifier in TABLE 1, the CPU0 processor 110 may identify Port 4 of CPU2 socket 130, Port 4 of CPU2 socket 130, Ports 0 and 1 of IOH1 socket 132 as candidate ports to be enabled in order to establish links 140 to the IOH1 socket 132. The CPU0 processor 110 may further determine based upon established link information of the dynamic topology table 170 shown in TABLE 2 whether any of the candidate ports have already established links. As depicted by the last row of TABLE 2, none of the ports of the IOH1 socket 132 have been enabled.

The CPU0 processor 110 then at block 240 may enable the ports identified in block 230. Furthermore, the CPU0 processor 110 may determine whether links 140 associated with the enabled ports have been successfully established. In particular, the CPU0 processor 110 in response to the IOH1 I/O hub 125 being added to the IOH1 socket 132 may enable Port 4 of CPU2 socket 130, Port 4 of CPU2 socket 130, Ports 0 and 1 of IOH1 socket 132 and determine whether the link 140 between Port 4 of CPU2 socket 130 and Port 0 of IOH1 socket 132 was successfully established and whether the link 140 between Port 4 of CPU 3 and Port 1 of IOH1 socket 132 was successfully established. If any of the links 140 associated with the enabled ports failed, the CPU0 processor 110 may disable the ports associated with the failed links 140.

The CPU0 processor 110 at block 250 may determine system routing information that accounts for the added IOH1 I/O hub 125 and may update the dynamic topology table 170 accordingly. In particular, the CPU0 processor 110 may use a path-searching algorithm and the distance information of the dynamic topology table 170 to find paths between the added IOH1 socket 132 and the other sockets 130, 132 of the computing device 100. In another embodiment, the firmware device 155 may store routing tables for every supported socket configuration of the computing device 100. In such an embodiment, the CPU0 processor 110 may update the link connection information of the dynamic topology table 170 to reflect the addition of the IOH1 I/O hub 125 to the IOH1 socket 132 and identify the current configuration of the computing device 100 based on the updated dynamic topology table 170. The CPU0 processor 110 may then retrieve the routing information from the firmware device 155 that corresponds to the current configuration of the computing device 100.

TABLES 4 and 5 show the status of the dynamic topology table 170 after the CPU0 processor 110 updates the dynamic topology table 170 to reflect the addition of the IOH1 I/O hub 125.

TABLE 4
Dynamic Topology Table Connection Information

| | CPU0 | CPU2 | CPU3 | CPU1 | IOH0 | IOH1 |
|---|---|---|---|---|---|---|
| CPU0 | n/a | 1 | 2 | 3 | 4 | n/a |
| CPU2 | 3 | n/a | 1 | 2 | n/a | 4 |
| CPU3 | 2 | 3 | n/a | 1 | n/a | 4 |
| CPU1 | 1 | 2 | 3 | n/a | 4 | n/a |
| IOH0 | 0 | n/a | n/a | 1 | n/a | n/a |
| IOH1 | n/a | 0 | 1 | n/a | n/a | n/a |

TABLE 5
Dynamic Topology Table Shortest Route Information

| | CPU0 | CPU2 | CPU3 | CPU1 | IOH0 | IOH1 |
|---|---|---|---|---|---|---|
| CPU0 | 0 | 1 | 1 | 1 | 1 | * |
| CPU2 | 1 | 0 | 1 | 1 | 2 | 1 |
| CPU3 | 1 | 1 | 0 | 1 | 2 | 1 |
| CPU1 | 1 | 1 | 1 | 0 | 1 | * |
| IOH0 | 1 | 2 | 2 | 1 | 0 | * |
| IOH1 | * | 1 | 1 | * | * | 0 |

After updating the dynamic topology table 170 and determining system routing information that reflects the addition of the IOH1 I/O hub 125, the CPU0 processor at block 260 may update the routing table arrays and the system address decoders of each of the sockets 130, 132 to account for the addition of the IOH1 I/O hub 125. Furthermore, the CPU0 processor at block 270 may unquiesce the processors 110 and the I/O hubs 125 of computing device 100 to permit traffic through the links 140.

The above description addresses how to hot added components to a socket 130, 132. However, the above process is also applicable to hot removal of a component from a socket 130, 132. For such case, ports are not enabled but disabled for the socket 130, 132 associated with the removed component. Furthermore, the above description uses an system management interrupt to signal a hot add or a hot removal event. The hot add or hot removal event may be detected using other techniques such as generating other types of interrupts (e.g. platform management interrupts or non-maskable interrupts) or polling registers associated with the sockets 130, 132 to detect the addition or removal of a component.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

What is claimed is:

1. A computing device, comprising
a plurality of sockets to receive components of the computing device, each socket having one or more ports and an associated socket identifier,
a plurality of links to interconnect the plurality of sockets, each link to statically connect one port of a socket with one port of another socket,
a static topology table to identify for each socket identifier the one or more ports of the associated socket and to identify to which port of another socket that each port of the one or ports of the associated socket is connected, and
a processor coupled to a socket of the plurality of sockets, the processor to obtain the socket identifier of a socket of an added component, to determine which ports of the plurality of sockets are connected to the socket of the added component based upon the obtained socket identifier and the static topology table, and to enable one or more of the ports connected to the socket of the added component to establish one or more links of the plurality of links between the socket of the added component and other sockets of the plurality of sockets.

2. The computing device of claim 1, further comprising a dynamic topology table to identify enabled ports of the plurality of ports and sockets to which the enabled ports are connected, wherein
the processor is to determine which ports of the plurality of sockets to enable based upon the dynamic topology table.

3. The computing device of claim 1, further comprising a dynamic topology table to identify enabled ports of the plurality of ports and the sockets to which the enabled ports are connected, wherein
the processor is to update the dynamic topology table to reflect that the one or more ports connected to the socket of the added component are enabled.

4. The computing device of claim 1, further comprising a dynamic topology table to identify enabled ports of the plurality of ports and the sockets to which the enabled ports are connected, wherein
the processor is to update the dynamic topology table to reflect that a port connected to the socket of the added component is enabled after determining that the link between the port and the socket of the added component has been successfully established.

5. The computing device of claim 1, wherein the processor is to update a routing table associated with each components of the plurality of sockets to reflect a route between each component and the added component.

6. The computing device of claim 1, further comprising a dynamic topology table to identify enabled ports of the plurality of ports, the sockets to which the enabled ports are connected, and a distance between each socket of the plurality of sockets, wherein
the processor is to update the dynamic topology table to reflect that a port connected to the socket of the added component is enabled, and is to reflect distances between the socket of the added component and other sockets of the plurality of sockets.

7. The computing device of claim 1, further comprising a dynamic topology table to identify enabled ports of the plurality of ports, and the sockets to which the enabled ports are connected, wherein
the processor is to obtain the socket identifier of a socket of a removed component, is to determine which ports of the plurality of sockets are connected to the socket of the removed component based upon the static topology table and the obtained socket identifier for the socket of the removed component, is to disable one or more of the ports connected to the socket of the removed component to disable one or more links between the socket of the removed component and other sockets of the plurality of sockets, is to update the dynamic topology table to reflect that a port connected to the socket of the added component is enabled, and is to update the dynamic topology table to reflect that the one or more ports connected to the socket of the removed component are disabled.

8. A machine readable medium comprising a plurality of instructions that in response to being executed, result in a computing device in response to a component being added to a socket of a plurality of sockets that each have a socket identifier,
retrieving the socket identifier of the socket of the added component,
determining which ports of the plurality of sockets are connected to the socket of the added component based upon the obtained socket identifier and a static topology table that is to identify static link connections between ports of the plurality of sockets, and
enabling one or more of the ports connected to the socket of the added component to establish one or more links between the socket of the added component and other sockets of the plurality of sockets.

9. The machine readable medium of claim 8, wherein the plurality of instructions further result in the computing device determining which ports of the plurality of sockets to enable based upon a dynamic topology table that is to identify enabled ports of the plurality of ports and sockets to which the enabled ports are connected.

10. The machine readable medium of claim 9, wherein the plurality of instructions further result in the computing device updating the dynamic topology table to reflect that the one or more ports connected to the socket of the added component are enabled.

11. The machine readable medium of claim 9, wherein the plurality of instructions further result in the computing device updating the dynamic topology table to reflect that a port connected to the socket of the added component is enabled after determining that the link between the port and the socket of the added component has been successfully established.

12. The machine readable medium of claim 11, wherein the plurality of instructions further result in the computing device updating the dynamic topology table to reflect distances between the socket of the added component and other sockets of the plurality of sockets.

13. The machine readable medium of claim 8, wherein the plurality of instructions further result in the computing device updating a routing table associated with a resident component of the plurality of sockets to reflect a route between the resident component and the added component.

14. The machine readable medium of claim 8, wherein the plurality of instructions further result in the computing device in response to a component being removed from a socket of the plurality of sockets,
retrieving the socket identifier of the socket of the removed component,
determining which ports of the plurality of sockets are connected to the socket of the removed component based upon the static topology table and the obtained socket identifier for the socket of the removed component, and
disabling one or more of the ports connected to the socket of the removed component to establish one or more links between the socket of the added component and other sockets of the plurality of sockets.

15. The machine readable medium of claim 14, wherein the plurality of instructions further result in the computing device,
updating a dynamic topology table, that is to identify enabled ports of the plurality of ports and sockets to which the enabled ports are connected, to reflect that the one or more ports connected to the socket of the removed component are disabled.

16. In response to a component being added to a socket of a plurality of sockets that each have a socket identifier, a method, comprising
retrieving the socket identifier of the socket of the added component,
determining which ports of the plurality of sockets are connected to the socket of the added component based upon the obtained socket identifier and a static topology table that is to identify static link connections between ports of the plurality of sockets, and
enabling one or more of the ports connected to the socket of the added component to establish one or more links between the socket of the added component and other sockets of the plurality of sockets.

17. The method of claim 16, further comprising determining which ports of the plurality of sockets to enable based upon a dynamic topology table that is to identify enabled ports of the plurality of ports and sockets to which the enabled ports are connected.

18. The method of claim 17, further comprising updating the dynamic topology table to reflect that the one or more ports connected to the socket of the added component are enabled.

19. The method of claim 17, further comprising updating the dynamic topology table to reflect that a port connected to the socket of the added component is enabled after determining that the link between the port and the socket of the added component has been successfully established.

20. The method of claim 19, further comprising updating the dynamic topology table to reflect distances between the socket of the added component and other sockets of the plurality of sockets.
